(19) United States
(12) Patent Application Publication
(10) Pub. No.: US 2022/0081332 A1
(43) Pub. Date: Mar. 17, 2022

(54) Tailings Treatment Process

(71) Applicant: Dow Global Technologies LLC, Midland, MI (US)

(72) Inventors: Lizbeth Rostro, Lake Jackson, TX (US); Wu Chen, Lake Jackson, TX (US); Paul A. Gillis, Lake Jackson, TX (US); Michael K. Poindexter, Sugar Land, TX (US)

(21) Appl. No.: 17/419,903

(22) PCT Filed: Jan. 25, 2020
(86) PCT No.: PCT/US2020/015121

§ 371 Date: Jun. 30, 2021

Related U.S. Application Data
(60) Provisional application No. 62/798,088, filed on Jan. 29, 2019.

(51) Int. Cl. C02F 1/56; C02F 11/127; C02F 11/147; B01F 23/53; B01F 27/115; B01F 35/71

(52) U.S. Cl. CPC C02F 1/56; C02F 11/127; C02F 11/147; C02F 2103/10; B01F 27/115; B01F 35/71731; B01F 23/53

(57) ABSTRACT

Embodiments relate continuous process for treating tailings that includes providing tailings for treatment having at least 20 wt % solids, providing a mixing apparatus having a first inlet for feeding the tailings, a second inlet for feeding flocculants, an outlet for a mixture of the tailings and flocculants, and a rotating disk, the first inlet being separate from the second inlet, the second inlet being above the rotating disk, and the rotating disk having a tip speed at least 2 m/s, continuously introducing into the mixing apparatus the tailings through the first inlet and the flocculants through the second inlet, allowing the tailings and the flocculants to mix on the rotating disk to form the mixture of the tailings and flocculants, continuously removing the mixture of the tailings and flocculants through the outlet to form a treated mixture, and flowing the treated mixture from the mixing apparatus for further treatment or to a disposal area.

### FIELD

Embodiments relate to a mixing apparatus for a treatment process for tailings, e.g., from oil sands and mineral mines, that enables direct dispersion of flocculants, a process for using the apparatus in the treatment process, and tailings treated using the treatment process.

### INTRODUCTION

A flocculation process may be used in the treatment of slurries to separate solids from liquids and/or other solids. Flocculation is a process wherein particles aggregate, perhaps based on the addition of additives such as flocculants. For example, flocculation may be used for enhancing dewatering of aqueous waste streams created during the surface mining of oil sands (also known as tailings or mature fine tailings streams), and/or the extraction of valuable components (such as bitumen, phosphate, diamond, gold slimes, mineral sands, tails from zinc, lead, copper, silver, uranium, nickel, iron, or coal). However, due to the rheological properties of the slurries and/or additive streams, difficulties can be encountered with the blending of the additive and the process streams. Therefore, alternatives are sought that at least better enable the addition of additives, such as solid flocculants, to slurries such as tailings from oil sands and mineral mines, and potentially allow for improved processability and final results.

### SUMMARY

Embodiments may be realized by providing a continuous process for treating tailings that includes providing tailings for treatment having at least 20 wt % solids, based on a total weight of the tailings, providing a mixing apparatus having a first inlet for feeding the tailings, a second inlet for feeding flocculants, an outlet for a mixture of the tailings and flocculants, and a rotating disk, the first inlet being separate from the second inlet, the second inlet being above the rotating disk, and the rotating disk having a tip speed at least 2 m/s, continuously introducing into the mixing apparatus the tailings through the first inlet and the flocculants through the second inlet, allowing the tailings and the flocculants to mix on the rotating disk to form the mixture of the tailings and flocculants, continuously removing the mixture of the tailings and flocculants through the outlet to form a treated mixture, and flowing the treated mixture from the mixing apparatus for further treatment or to a disposal area.

### BRIEF DESCRIPTION OF THE DRAWINGS

Features of the embodiments will become more apparent to those of ordinary skill in the art by describing in detail exemplary embodiments thereof with reference to the attached drawings in which:

FIG. 1 illustrates a top view of an exemplary horizontal rotor;

FIG. 2 illustrates a side view of an exemplary horizontal rotor; and

FIG. 3 illustrates a side view of an exemplary vertical rotor.

### DETAILED DESCRIPTION

Waste material in the form of a slurry, such as tailings from oil sands and mineral mines, may be disposed of by pumping the slurry to a disposal area such as back down the mine, to open mines, to pits, to lagoons, to heaps or to stacks and allowing it to dewater through the actions of sedimentation, drainage, evaporation, and consolidation. For example, the waste material may be transferred along a conduit (such as a pipe or trench) and through an outlet to a deposition area, where the material will then be allowed to dewater and optionally consolidate upon standing.

A flocculation process may be used to treat slurries such as tailings from oil sands or mineral mines. The flocculation process may enable dewatering of the slurry over a period of time extending from hours to years. Dewatering of the treated slurry may allow for reduction of space required in the disposal area for storage of the treated slurries (such as in disposal areas for oil sands). Further, as the solids content of the treated slurries increases, the likelihood of being able to repurpose the storage area may increase. For example, if the solids content of the treated slurries is at least 45 wt % (e.g., at least 55 wt %), the treated slurries may be placed in a disposal area that can be repurposed as a green area that enables the growth of trees, plants, vegetation, etc. A workable solids content for repurposing the disposal area may be reached over an extended period of time, e.g., over period from 1 year to 15 years, from 1 year to 10 years, from 1 year to 5 years, etc.

During the flocculation process, the slurry may be fed to a vessel or pipe in which the flocculant is added. The slurry may have a solids content of at least 20 wt % (e.g., from 20 wt % to 80 wt %, from 20 wt % to 60 wt %, 20 wt % to 55 wt %, from 20 wt % to 50 wt %, from 20 wt % to 40 wt %, from 30 wt % to 45 wt %, from 30 wt % to 40 wt %, etc.), based on a total weight of the slurry. The solids may be minerals from oil sands or mines that are suspended in water to form the slurry. The solids may be particles from fine tailings and/or coarse tailings. The particles of the fine tailings may have a mean particle size of less than 45 microns, e.g., 95% of the particles may have a particle size of less than 20 microns. The particles of the coarse tailings may have a mean particle size of greater than 45 microns, e.g., 85% of the particles may have a particle size of greater than 100 microns (may be less than 8,000 microns).

The flocculation process may include the addition of flocculants (e.g., one or more different polymers that enable dewatering by promoting aggregation of the solids) to the slurry. The flocculants may be added in an effort to increase the dewatering and/or recovery of solids, e.g., interactions between the flocculants and solids in the slurry may enable and/or improve the release of water from the slurry. However, designing a flocculation process that enables the effective addition of flocculants may be challenging, especially when the flocculants are added as a pre-formed solution, dispersion or powder. In this regard, in some instances it is necessary to form hydrated flocculants as a pre-formed solution or dispersion of the flocculants, using a solvent such as water, to allow for effective mixing of the flocculants into the slurry (e.g., tailings stream). By pre-formed solution, it is meant a material that has been pre-formed prior addition to the slurry as a solution that includes a mixture of a liquid phase (such as water and/or dispersing agents) and a solid phase (such as a flocculant). By pre-formed dispersion it is meant a material that is pre-formed prior to addition to the slurry into a continuous liquid phase at ambient conditions and atmospheric pressure, which dispersion is derived from a liquid phase (such as water and/or dispersing agents) and a solid phase (such as a flocculant).

Further, the use of the hydrated flocculant provides many challenges for commercial implementation. For example, the hydration of flocculants contributes to higher operational costs because forming the hydrated flocculants is a time consuming process, e.g., may take at least a day to form the hydrated flocculants, and may necessitate a substantial investment in terms of stir tanks, storage tanks, hydration equipment, etc. Also, commercial use of the hydrated flocculants may provide processability difficulties because a substantial amount of dewatering may occur soon after the hydrated flocculant is added. This limits how far the treated slurry may be transported, such as from a treatment area to a disposal area, before a substantial amount of dewatering has occurred such that transportation will become more difficult. In addition, if a transportation issue is encountered, such as a pump becomes inoperable, during the delay in resuming operation of the pump, the transportation line may become blocked with dewatered slurry, which may necessitate further downtime for cleanup.

Also, the hydration of flocculants may utilize a substantial amount of water that is further added to the slurry, which increases the total amount of water that needs to be removed from the treated slurry in order to enable repurposing of the disposal area.

Accordingly, use of hydrated flocculants may provide a specific type of floc structure within the treated slurry/tailings that will facilitate the release of water, but which floc structure may provide limitations for commercial use, processability, and final solids content. As such, a flocculation process that minimizes and/or avoids the use of hydrated flocculants is sought, while still enabling sufficient mixing and potentially increasing the final solids content to better enable repurposing of the disposal area. As such it is proposed to use a mixing apparatus that is a disperser to directly add the flocculant (e.g., non-hydrated flocculants in powder form) to the slurry to form the treated slurry. By use of such a mixing apparatus, use of hydrated flocculants may be minimized and/or avoided so as to allow for a reduction in operational costs for commercial use, improved processability, and potentially improved dewatering results. In exemplary embodiments, the non-hydrated flocculants in powder form used in the continuous process of treating tailings may account for at least 50%, at least 80% at least 90%, at least 95%, at least 98%, at least 99%, and/or 100% of the total flocculants used. With use of the mixing apparatus, the use of non-hydrated flocculants may be excluded in the process of forming treated tailings.

### Mixing Apparatus

The mixing apparatus for the addition of flocculants is a disperser that is able to achieve high tip speeds of at least 2 m/s (e.g., at least 8 m/s, at least 9 m/s, at least 10 m/s, from 2 m/s to 50 m/s, 3 m/s to 40 m/s, from 5 m/s to 30 m/s, from 8 m/s to 20 m/s, from 8 m/s to 15 m/s, from 8 m/s to 12 m/s, etc.). By tip speed it is meant the linear velocity of the outer edge of rotator. The apparatus allows for the flocculant (such as in powder form, without the presence of added solvent and not in the form of a pre-formed solution or dispersion) and the slurry (such as tailings having a high solids content) to be subjected to shear forces that provide the blending and phase interactions sought to contact the flocculants with the slurry to allow for separation/dewatering of the treated slurry. The mixing apparatus may include one or more rotor and stator sets. The tip speed of the mixing apparatus may be adjust the amount of shear applied to the mixture of flocculants and slurry.

The mixing apparatus may not be used as a solid/liquid disperser as the slurry has a solids content of a high solids content of at least 20 wt % (not typically regarded as a liquid), and the flocculants are not hydrated prior to being mixed in the apparatus with the slurry. The apparatus may be used to allow mixing of the two solids, e.g., the solids in the slurry and the flocculants in powder form, to form a treated slurry. The treated slurry made using the apparatus behaves substantially differently from a treated slurry formed without the apparatus and/or with use of hydrated flocculants.

The mixing apparatus may be an in-line powder disperser that may be incorporated into a flocculation process for processing tailings from oil sands or mines. The apparatus may allow for single pass, continuous mixing of the flocculants in powder form and the tailings with a solids content of at least 20 wt % through recirculating powder dispersion, after which the mixed flocculants and solids in the tailings may be fed for further processing downstream or directly to a deposition site for the final processing of the tailings.

The apparatus is configured such that the flocculant can be dropped (e.g., due to gravitational forces) onto a rotating disk. While the apparatus advantageously allows for the direct addition of the flocculant as a solid powder or highly viscous material without pre-forming a solution/dispersion, the apparatus may be used with a pre-formed solutions and/or dispersion of the flocculant. The apparatus may be used with various flocculants, such as thermoplastic polymers. Exemplary polymers include alpha olefin polymers, functionalized alpha olefin polymers, alpha olefin copolymers, functionalized alpha olefin copolymers, polyurethane polymers, polyester polymers, acrylic polymers, epoxy polymers, phenolic polymers, silicone polymers, nylon polymers, and HPAM (partially hydrolyzed polyacrylamide) polymers. The flocculants may include one or more polyethylene oxide polymer (PEO) having a number average molecular weight of at least 100,000 g/mol (e.g., from 100,000 to 100,000,000 g/mol; from 100,000 to 50,000,000 g/mol; from 1,000,000 to 30,000,000; from 1,000,000 to 20,000,000; from 1,000,000 to 15,000,000 g/mol; from 5,000,000 to 10,000,000; from 7,000,000 to 9,000,000; etc.) In exemplary embodiments, the PEO may be a combination of PEOs, e.g., as discussed in International Publication No. WO2017/205249.

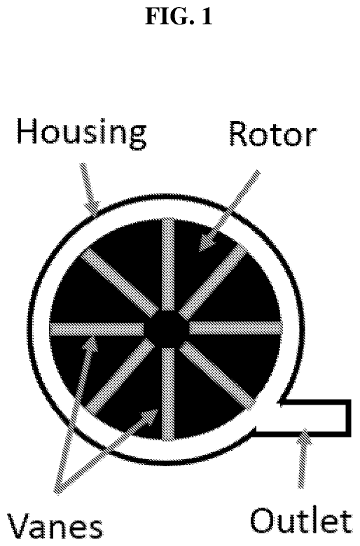

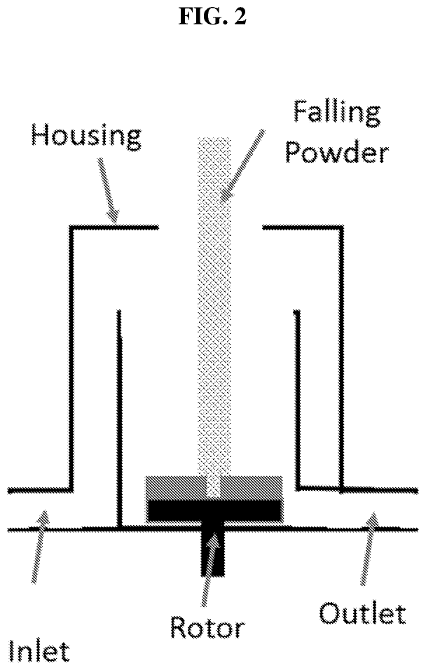

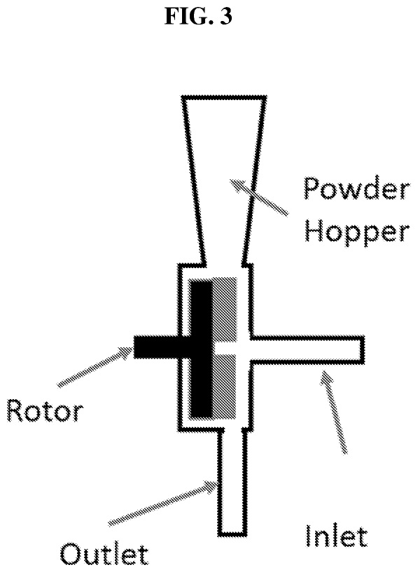

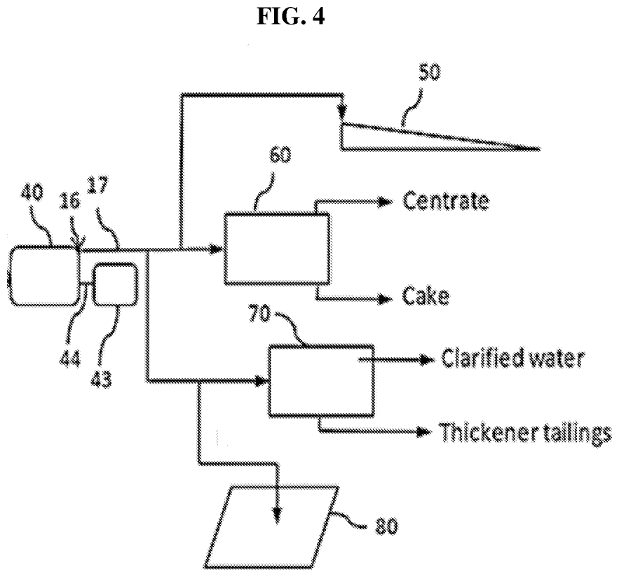

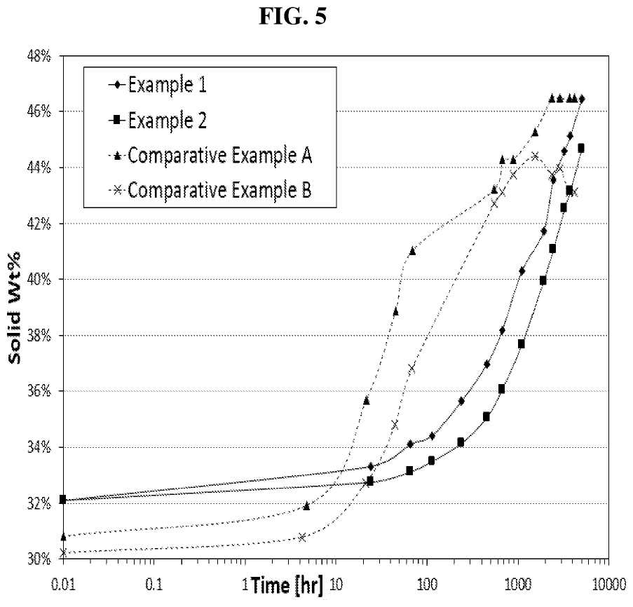

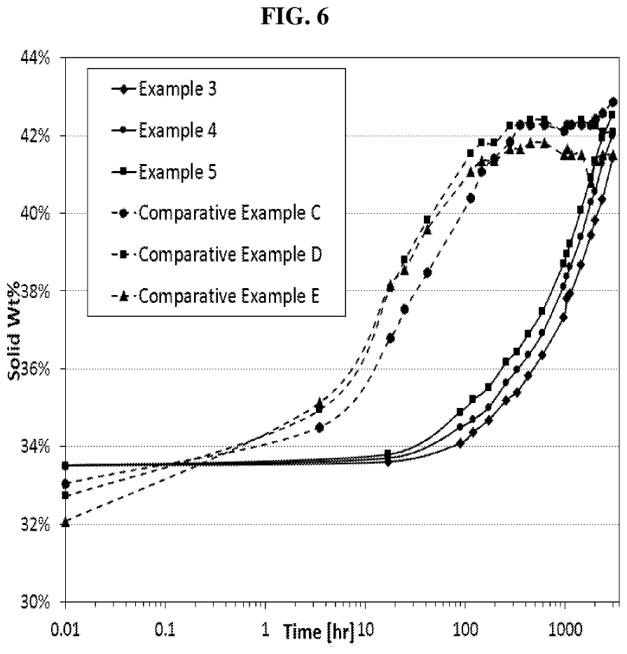

Referring to FIGS. 1 and 2, the mixing apparatus may include a Housing that encloses an open rotating disk with a plurality of Vanes. The Vanes may be attached to the disk such that a Rotor is used to enable rotation of the disk and Vanes. The mixing apparatus may include at least 5 Vanes (from 5 Vanes to 1000 Vanes, from 8 Vanes to 100 Vanes, etc.) that are spaced apart from each other on the rotating disk. The Vanes may extend upward from the rotating in a pattern that forms a plurality of voids that expose the underlying rotating disk. The Vanes may define The rotating disk may be part of the Rotor.

The mixing apparatus includes an Inlet (i.e., first inlet) for feeding the slurry (tailings). The first inlet may be formed in the Housing of the mixing apparatus. The slurry may be stored in a location that is outside the Housing and is separate from the location where the flocculants are stored. The slurry is a suspension that is fed to the mixing apparatus with sufficient flow characteristics to allow for mixing with the flocculants on the rotating disk. The slurry may be pumped into the Housing in such a manner that the viscous slurry may travel over the rotating disk and the Vanes to be dropped on the rotating disk

The mixing apparatus includes a second inlet for feeding flocculants. The second inlet may be formed in the Housing of the mixing apparatus. The second inlet may be an opening that overlaps the rotating disk (e.g., facing a top of the rotating disk or a side of the rotating disking) to allow for the flocculants to be dropped onto the Vanes and rotating disk. For example, the opening may completely overlap the top of the rotating disk or at least partially overlap the side of the rotating disking. The flocculants may be stored in a location that is outside the Housing, e.g., in powder form as non-hydrated flocculants. In exemplary embodiments, the flocculants may be dropped from a pipe that is outside the Housing and/or may be dropped through a hopper that is above the Housing.

The mixing apparatus includes an Outlet, which may be near the Vanes, for enabling a mixture of the slurry and flocculants to exit the Housing and mixing apparatus. For example, after mixing of the slurry and the flocculants by the Rotor and Vanes a treated mixture is formed that will exit the mixing apparatus and be flowed for further processing or to a disposal area to allow for separation/dewatering. For example, the treated mixture may flowed from the mixing apparatus to further treatment in a centrifuge, thickener, and/or accelerated dewatering cell and then further flowed from the centrifuge, thickener, and/or accelerated dewatering cell to the disposal area. The Vanes may impart momentum to the treated mixture to aid the flow of the material exiting the device. The orientation of the mixing apparatus, with regard to the ground, in the process is not limited, it may be horizontal, vertical, or at any angle in between.

The treated mixture is flowed to the optional further processing and eventually to a disposal area for dewatering. In exemplary embodiments, for a period of at least 1000 hours after flowing the treated mixture from the mixing apparatus, the treated mixture has a solids content of at least 42 wt %, based on a total weight of the treated mixture. For a period of at least 1500 hours after flowing the treated mixture from the mixing apparatus, the treated mixture may have a solids content of at least 43 wt %, based on a total weight of the treated mixture. The solids content after the period of at least 1000 hours and/or at least 1500 hours may be higher when using the mixing apparatus with non-hydrated flocculants as compared to when the hydrated flocculants are used without this mixing apparatus. Accordingly, use of the mixing apparatus may increase the likelihood of obtaining a sufficient amount of dewatering to allow for repurposing of the disposal area.

Further, the treated mixture may be storage stable after exiting the mixing apparatus, so as allow for improved processability and flexibility with respect to transportation and processing difficulties. In exemplary embodiments, for a period of at least 100 hours after flowing the treated mixture from the mixing apparatus, the treated mixture is storage stable such that there is less than 2 wt % difference in solids content over the period of time of at least 100 hours. By less than 2 wt % difference in solids content it is meant that the difference in solids content of the treated slurry after leaving the mixing apparatus (approximately 0.01 hours) is less than 2 wt % as compared to the solids content of the treated slurry at least 100 hours after the treated mixture leaves the mixing apparatus (which solid content is based on the total weight of the treated mixture at the at least 100 hours after leaving the mixing apparatus). As such, when the delta in solids content at least 100 hours after leaving the mixing apparatus is less than 2 wt %, the treated mixture is determined to be storage stable. In exemplary embodiments, the treated mixture may be storage stable for a period of at least 50 hours after flowing the treated mixture from the mixing apparatus such that there is less than 1 wt % difference in solids content.

### Flocculation Process and Flocculants

An exemplary flocculation process may include a feed line for the slurry (such as tailings from oil sands or mineral mines) to be pumped through a pipeline to the mixing apparatus 40 shown in FIG. 4. Water may be added to the slurry prior to being feed to the mixing apparatus 40 to adjust the solids content of the slurry. The flocculants may be stored in tank/hopper 43 and fed to the mixing apparatus 40 through line 44. According to embodiments, the tank/hopper 43 allows for the direct addition of the flocculants without pre-forming a solution or dispersion. The tank/hopper 43 may allow for lower operational costs as use thereof avoids the use of equipment for the formation and storage of hydrated flocculants. The treated mixture of the slurry and the flocculants may initially, and potentially for a period of at least 50 and/or at least 100 hours after leaving the mixing apparatus 40, have a low viscosity (e.g., less than 10,000 cP, less than 8,000 cP, less than 6,000 cP, less than 4,000 cP, etc.), as determined using a Brookfield DV3T viscometer with a V73 spindle at ambient conditions. The treated mixture may have a relatively stable viscosity for the period after leaving the mixing apparatus 40, such that formation of a high viscosity dough-like material may be minimized and/or avoided (for at least several hours after leaving the mixing apparatus 40). For example, if the dough-like mixture is formed, it may not be formed for at least 100 hours after leaving the mixing apparatus 40.

The outlet 16 of the mixing apparatus 40 flows into line 17. The internal diameter of pipe 17 may be the same, larger, or smaller than the internal diameter of the reactor outlet pipe 16. Once material has exited the mixing apparatus 40, it may be further treated and/or deposited in a deposition area.

Exemplary processes are described as follows, which may be used alone or in various combinations. In an exemplary embodiment, an in-line reactor (not shown) after the mixing apparatus 40 to further facilitate blending and interactions between the slurry and the flocculants. The in-line reactor may include one or more rotors and/or one or more stators. In an exemplary embodiment, the mixture may be transported to a thin lift sloped deposition site 50 (e.g., having a slope of 0.5% to 4% to allow water drainage). The water drainage may allow the material to dry at a more rapid rate and reach trafficability levels sooner. Additional layers can be added and allowed to drain accordingly. In another exemplary embodiment, the mixture is transferred to a centrifuge 60. A centrifuge cake solid containing the majority of the fines and a relatively clear centrate having low solids concentrations may be formed in the centrifuge 60. The centrifuge cake may then be transported, e.g., by trucks, and deposited in a drying cell. In another exemplary embodiment, the mixture is removed and placed in a thickener 70, which may produce clarified water and thickened tailings for further disposal. In another exemplary embodiment, the mixture is deposited at a controlled rate into an accelerated dewatering cell 80, e.g., a tailings pit, basin, dam, culvert, or pond, or the like which acts as a fluid containment structure. The containment structure may be filled with the mixture continuously or the mixture can be deposited in layers of varying thickness. The water released may be removed using pumps. The deposit fill rate may be such that maximum water is released during or just after deposition. Additional water may be released by the addition of an overburden layer to the deposited and chemically-treated tailings. Water release may be further facilitated by a process known as rim ditching where perimeter channels around the deposit are dug.

Through the process, the dewatered slurry may form a compact and dry solid mass through the actions of sedimentation, drainage, evaporative drying, and/or consolidation. The deposited particulate mineral material from the slurry may reach a substantially dry state.

An exemplary dewatering process for a slurry, such as tailings from oil sands, includes: (a) in a mixing apparatus according to embodiments mixing flocculants with the slurry to form a treated mixture; (b) allowing the mixture to flocculate; and (c) dewatering the treated mixture.

### EXAMPLES

Approximate properties, characters, parameters, etc., are provided below with respect to the illustrative working examples, comparative examples, and the information used in the reported results for the working and comparative examples.

Referring to FIG. 5, with respect to Examples 1 and 2 and Comparative Examples A and B, the oil sands Tailings 1 having an initial solids content of 32.1 wt % are treated with a Flocculant Composition, which is a powder of POLYOX™ WSR-308, a water-soluble grade PEO resin having an number average molecular weight of approximately 8,000,000 Da polymer available from The Dow Chemical Company. Referring to FIG. 6, with respect to Examples 3, 4, and 5 and Comparative Examples C, D, and E, the oil sands Tailings 2 having an initial solids content of 33.5 wt % are treated with Flocculant Composition.

To prepare Examples 1 to 5, a progressive cavity pump is used to fed a stream of the tailings into a Ytron ZCO in-line powder disperser apparatus (available from Quadro), which is set to 6500 rpm (approximately a tip speed of 10 m/s). The Flocculant Composition is metered in to the apparatus using a vibrating feeder. The stream of Tailings 1 or Tailings 2 is allowed to flow through the apparatus as the Flocculant Composition is delivered overhead using the vibrating feeder and allowed to fall onto a rotating disk in the apparatus. The Flocculant Composition is pushed outward by centrifugal forces created by the rotating disk in the apparatus to form treated Examples 1 to 5. The flow rate of the tailings is controlled (10 gpm for Example 1 and 5 gpm for Examples 2 to 5) using a progressive cavity pump from SEEPEX (SEEPEX BN5) that allows for two dosages to be evaluated: 214 ppm for Example 1; 428 ppm for Example 2; 164 ppm for Example 3; 283 ppm for Example 4; and 534 ppm for Example 5. The dosage is determined based on the solids content in the tailings stream. After treatment the samples are collected in 5 gallon containers and stored for monitoring of dewatering. Examples 1 and 2 are left to settle for a period over 3500 hours and the solids content over time is shown in FIG. 5. Examples 3, 4, and 5 are left to settle for a period over 3000 hours and the solids content over time is shown in FIG. 6.

To prepare Comparative Examples A to E, a progressive cavity pump is used to fed a stream of the tailings into a dynamic mixer. The Tailings 1 and 2 are treated with a 0.4 wt % aqueous solution of the Flocculant Composition. The aqueous solution is added using a progressive cavity pump from SEEPEX (SEEPEX MDP-12) that allows for different dosages and dynamic mixer rotational speeds to be evaluated: 556 ppm and 2000 rpm for Comparative Sample A; 752 ppm and 3000 rpm for Comparative Sample B; 164 ppm and 0 rpm for Comparative Sample C; 283 ppm and 0 rpm for Comparative Sample D; 534 ppm and 0 rpm for Comparative Sample E. After treatment the samples are collected in 5 gallon containers and stored for monitoring of dewatering. Comparative Examples A and B are left to settle for a period over 3500 hours and the solids content over time is shown in FIG. 5. Comparative Examples C, D, and E are left to settle for a period over 3000 hours and the solids content over time is shown in FIG. 6.

Referring to FIG. 5, it is shown that Examples 1 and 2 allow for significantly improved storage stability and a higher overall solids content, as compared to Comparative Examples A and B. In particular, referring to FIG. 5, it is seen that for a period of at least 100 hours after mixing, the solids content is relatively stable for Examples 1 and 2. In contrast, Comparative Examples A and B show a relatively high change in solids content over that period. Further, it is shown that while the solids content plateaus at approximately 44 wt % and 46 wt % for Comparative Examples B and A, respectively, Examples 1 and 2 do not demonstrate such a plateau effect with respect to solids content within that range for solids content. Accordingly, it is believed a higher final solids content may be achieved for Examples 1 and 2.

Similarly, referring to FIG. 6, it is shown that Examples 3, 4, and 5 allow for significantly improved storage stability and a higher overall solids content, as compared to Comparative Examples C, D, and E. In particular, referring to FIG. 6, it is seen that for a period of at least 100 hours after mixing, the solids content is relatively stable for Examples 3 to 5. In contrast, Comparative Examples C to E show a relatively high change in solids content over that period. Further, it is shown that while the solids content plateaus at approximately 42 wt % for Comparative Examples C to E, respectively, Examples 3 to 5 do not demonstrate such a plateau effect with respect to solids content within that range for solids content. Accordingly, it is believed a higher final solids content may be achieved for Examples 3 to 5.

1. A continuous process for treating tailings, the process comprising:
providing tailings for treatment having at least 20 wt % solids, based on a total weight of the tailings;
providing a mixing apparatus having a first inlet for feeding the tailings, a second inlet for feeding flocculants, an outlet for a mixture of the tailings and flocculants, and a rotating disk, the first inlet being separate from the second inlet, the second inlet being above the rotating disk, and the rotating disk having a tip speed at least 2 m/s;
continuously introducing into the mixing apparatus the tailings through the first inlet and the flocculants through the second inlet;
allowing the tailings and the flocculants to mix on the rotating disk to form the mixture of the tailings and flocculants;
continuously removing the mixture of the tailings and flocculants through the outlet to form a treated mixture; and
flowing the treated mixture from the mixing apparatus for further treatment or to a disposal area.

2. The process of claim 1, wherein for a period of at least 1000 hours after flowing the treated mixture from the mixing apparatus, the treated mixture has a solids content of at least 42 wt %, based on a total weight of the treated mixture.

3. The process of claim 1, wherein for a period of at least 100 hours after flowing the treated mixture from the mixing apparatus, the treated mixture is storage stable such that there is less than 2 wt % difference in solids content.

4. The process of claim 1, wherein for a period of at least 50 hours after flowing the treated mixture from the mixing apparatus, the treated mixture is storage stable such that there is less than 1 wt % difference in solids content.

5. The process as claimed in claim 1, wherein the second inlet overlaps the rotating disk.

6. The process as claimed in claim 1, wherein the treated mixture is flowed from the mixing apparatus to further treatment in a centrifuge, thickener, or accelerated dewatering cell and then is flowed from the centrifuge, thickener, or accelerated dewatering cell to the disposal area.

7. The process as claimed in claim 1, wherein the flocculants are a poly(ethylene oxide)(co)polymer having a number average molecular weight of at least 100,000 Da.

8. The process as claimed in claim 1, wherein the flocculants are non-hydrated flocculants in powder form.

9. The process as claimed in claim 1, wherein the tailings are oil sands tailings.

10. Treated tailings from oil sands, the tailings being treated according to the process as claimed in claim 1.
